(19) United States
(12) Patent Application Publication
(10) Pub. No.: US 2020/0364799 A1
(43) Pub. Date: Nov. 19, 2020

(54) Insurance recommendation engine

(71) Applicants: Michael K. Crowe, Winchester, MA (US); Suzanne Poirier, Bedford, NH (US)

(72) Inventors: Michael K. Crowe, Winchester, MA (US); Suzanne Poirier, Bedford, NH (US)

(21) Appl. No.: 16/876,061

(22) Filed: May 17, 2020

Related U.S. Application Data
(60) Provisional application No. 62/848,803, filed on May 16, 2019.

(51) Int. Cl. G06Q 40/08; G06F 16/2457

(52) U.S. Cl. CPC G06Q 40/08; G06F 16/24578

(57) ABSTRACT

A method and a system for recommending an insurance carrier. The method includes receiving at least one user preference from a consumer; receiving, from at least one third party, at least one rating for each of a plurality of insurance carriers; computing scores for each of the plurality of insurance carriers, the score based on the received at least one user preference and the received ratings; and recommending the insurance carrier with the highest score to the consumer. The system includes a consumer interface, a third party interface, and a processor configured to receive at least one user preference from a consumer at the consumer interface; receive, from at least one third party, at least one rating for each of a plurality of insurance carriers at the third party interface; compute scores for each of the plurality of insurance carriers, and output a recommendation of the insurance carrier.

### CROSS REFERENCE TO RELATED APPLICATIONS

The present application claims the benefit of and priority to U.S. provisional application No. 62/848,803, filed on May 16, 2019, the entire disclosure of which is hereby incorporated by reference as if set forth in its entirety herein.

### TECHNICAL FIELD

The present invention generally relates to insurance recommendation engines, and more specifically, to systems and methods of using ratings for insurance carriers to recommend insurance carriers to consumers.

### BACKGROUND

Shopping for insurance can be a confusing and expensive process. Consumers who either want or are legally obligated to carry insurance may struggle to determine which insurance company is the best fit for their unique risk profile and buying preferences. Insurance consumers engaging in the current market have limited access to binding price data, reliable references, and testimonials relating to insurance carriers.

In the currently available insurance marketplace, consumers have three main ways to shop for and purchase insurance. First, consumers can go directly to insurance companies that sell direct to consumers. Second, consumers can use an insurance agent who sells insurance as an appointed representative of specific insurance companies that pay said agents negotiated commissions. Third, consumers can enter lead generation sales funnels, most typically online, engaging with companies that collect personal information of a consumer and sell the collected data to insurance companies and other third party intermediaries who then solicit consumers.

Insurance companies pay financial incentives to agents so those agents will direct consumers to specific insurance brands. When agents concentrate more premium with a smaller number of insurance companies, they can earn commissions for hitting specified premium thresholds with a specific insurance carrier. The same is also true of insurance lead generation websites that make money by auctioning off a consumer's personal information to the highest bidder or to multiple third party insurance companies and, in other cases, third parties that wish to sell ancillary products or services (e.g. home security systems and mortgages).

Accordingly, there is a need for improved methods and systems to recommend insurance carriers to a consumer.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for recommending an insurance carrier. In some embodiments, the method includes receiving at least one user preference from a consumer; receiving, from at least one third party, at least one rating for each of a plurality of insurance carriers; computing scores for each of the plurality of insurance carriers, the score based on the received at least one user preference and the received ratings; and recommending the insurance carrier with the highest score to the consumer.

In some embodiments, the at least one user preference is selected from the group comprising risk profile, price, area availability, customer support, coverage, buying preference, and reliability. In some embodiments, the at least one user preference further includes a ranked preference among at least two other user preferences. In some embodiments, the method further includes facilitating communications between the consumer and the recommended insurance carrier to enable the purchase of an insurance policy. In some embodiments, the highest score indicates at least one of a high rating, a low price, or a good value assessed from the plurality of ratings. In some embodiments, the method is executed in a computing environment that is remote from the consumer. In some embodiments, the method further includes receiving data from at least one insurance carrier; and wherein computing scores for each of the plurality of insurance carriers comprises computing scores using the received insurance carrier data. In some embodiments, the received insurance carrier data comprises at least one of type of insurance, affinity served, consumer type, pricing data, coverage area, and purchasing information. In some embodiments, the at least one rating is selected from the group consisting of price, rating, customer service, and claim process. In some embodiments, the at least one rating is selected from the group comprising price, rating, customer service, and claim process.

In another aspect, embodiments relate to a system configured to recommend an insurance carrier. In some embodiments, the system includes a consumer interface; a third party interface; and a processor, the processor configured to: receive at least one user preference from a consumer at the consumer interface; receive, from at least one third party, at least one rating for each of a plurality of insurance carriers at the third party interface; compute scores for each of the plurality of insurance carriers, the score based on the received at least one user preference and the received ratings; and output a recommendation of the insurance carrier with the highest score to the consumer at the consumer interface.

In some embodiments, the insurance carrier may include at least one of a homeowner insurance, auto insurance, renter insurance, or motorcycle insurance carrier. In some embodiments, the at least one user preference is selected from the group comprising at least one of risk profile, price, area availability, customer support, coverage, buying preference, and reliability. In some embodiments, the at least one user preference further comprises a ranked preference among at least two other user preferences. In some embodiments, the plurality of ratings are numerical ratings. In some embodiments, the highest score indicates at least one of a high rating, a low price, or a good value assessed from the plurality of ratings. In some embodiments, the system further includes a translator configured to translate natural language of the plurality of third party ratings to a numerical grade, wherein the processor is configured to compute scores for each of the plurality of insurance carriers based on the numerical grade. In some embodiments, the processor is further configured to receive data from at least one insurance carrier and compute scores for each of the plurality of insurance carriers based on the received insurance carrier data. In some embodiments, the received insurance carrier data comprises at least one of type of insurance, affinity served, consume type, pricing data, coverage area, and purchasing information. In some embodiments, the at least one rating is selected from a group consisting of price, customer service, and claim process.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a block diagram of a method for recommending an insurance carrier in accordance with one embodiment;

FIG. 2 is a block diagram of a system for recommending an insurance carrier in accordance with one embodiment; and

FIG. 3 is a block diagram of an insurance recommendation engine in accordance with one embodiment.

In the drawings, like reference characters generally refer to corresponding parts throughout the different views.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments. The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Some embodiments described herein are directed to systems and methods of using ratings for insurance carriers to recommend insurance carriers to consumers. Embodiments of the system are directed to an insurance recommendation engine configured to use data collected from insurance customers to create personalized insurance recommendations utilizing data sets to provide unique, unbiased, and algorithmic recommendations to the consumer. Embodiments may provide personalized insurance recommendations for homeowners insurance, auto insurance, renter insurance, health insurance, motorcycle insurance, event insurance, or flood insurance carriers.

Embodiments may acquire insurance customer feedback, analyze the feedback, and apply the information when generating an insurance recommendation for a potential new consumer. In some embodiments, the system may be configured to validate the feedback before using the information when generating an insurance recommendation based on the risk characteristics and buying preferences of the new consumer.

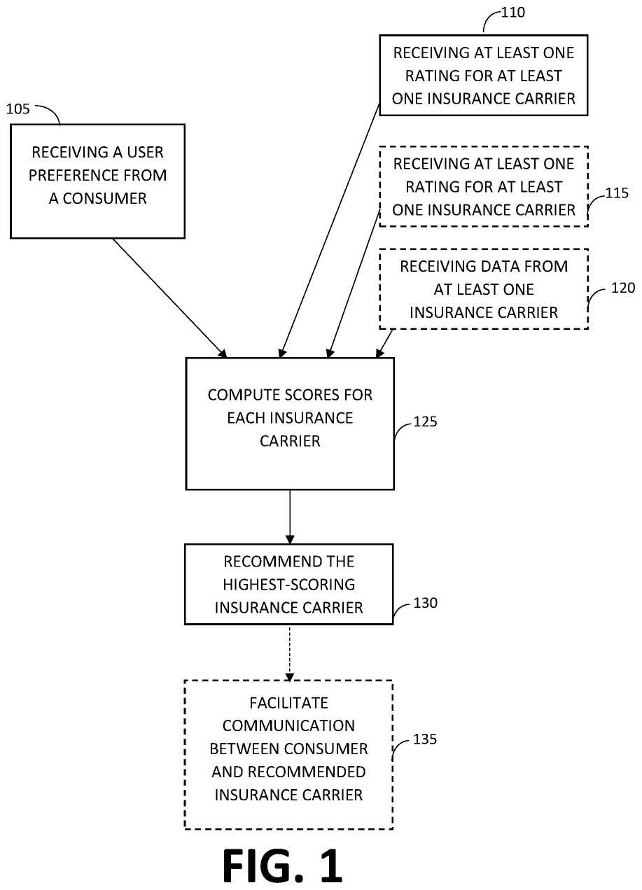

FIG. 1 depicts a method for recommending an insurance carrier in accordance with one embodiment. In some embodiments, the method includes receiving one or more user preference(s) from a consumer (step 105). A user preference may include buying preferences, the weighted relative importance of those preferences, and the needs of the user. For example, a user may specify that it is important for the insurance price to be under a specified monthly rate and for the insurance price to cover at least one student driver. Another user's preferences may include a weighted relative importance of generated company ratings, price sensitivity and an insurance reliability score that measures an insurance company's performance as a function of claim processing and payment performance.

The user may prefer that the insurance company offers homeowner's insurance, car insurance, and motorcycle insurance so that the user can consolidate monthly insurance payments with a single carrier. The user preference may also include the insurance risk profile and needs of the user. For example, the profile and needs may include requirements of teenage driver coverage, traffic violations, or a home in a flood zone. The user may also rank a plurality of preferences.

In some embodiments, the method may further include receiving at least one rating for at least one insurance carrier from one or more sources (steps 110, 115). The ratings may include reviews of experiences with certain insurance companies from current and past insurance consumers. For example, insurance consumers may be able to rate their insurance companies by reliability, service rating, likelihood they would recommend their insurance company to another user, and a price transparency rating. The consumer may be required to provide information, such as how long they have been a customer of the insurance carrier, if they work for the insurance carrier, and if they have filed a claim with the insurance carrier. The consumer may also be able to provide information in their rating regarding if they are a non-standard risk consumer, such as a teenage driver.

The ratings may be textual ratings or numerical ratings. The consumer data and evaluations may come from a user-supplied survey or may be obtained from third party sources. In some embodiments, the method may standardize verbal ratings or ratings on third party sources to use in further computations with a translator, as discussed in further detail below.

In some embodiments, the method may further include receiving data from at least one insurance carrier (step 120). In some embodiments, data from an insurance carrier may include prices for various insurance categories, discounts, area availability, affinity served, coverage, number of claims filed and fulfilled in a given time period, and types of insurance offered. For example, an auto insurance carrier may provide data regarding the standard price of auto insurance, the price of adding an additional vehicle, the incremental price of adding a teenage driver, additional motorcycle or RV insurance offered by the company, and the types of accidents covered by the policy.

In some embodiments, the method may include computing scores for each insurance carrier (step 125). This computation may include at least one of the following data points: (1) the overall customer rating and ranking of each insurance company, (2) the reliability index of each insurance company, (3) the claim service rating of each insurance company, (4) the likelihood that a customer would recommend the company to a friend, and (5) the price transparency rating of each insurance company. In some embodiments, the reliability index may refer to the perceived reliability of the insurance company based upon data inputs collected and aggregated from consumer ratings. In some embodiments, the claim service rating may be based upon data inputs collected and aggregated from consumers relating to insurance carrier service received based on the filing of an insurance claim. The method may include weighting the data points to calculate an overall score for each insurance company. In some embodiments, the data points may be weighted equally. In some embodiments, the data points may be weighted according to a user preference. In some embodiments, the calculations may include the volume of customer reviews and a system applying the method may assign weighting to the statistical validity and overall score.

In some embodiments, after computing scores for each insurance carrier 125, the method may include recommending the highest-scoring insurance carrier to a user (step 130). The highest-scoring insurance carrier may be the best recommended insurance company for the user based upon aggregated data sets collected from other users 110 and the user preferences 105. In some embodiments, the system may output the scores of a plurality of insurance carriers, ranking the insurance carriers in order of their computed scores.

In some embodiments, the method further includes facilitating communication between a consumer and a recommended insurance carrier (step 135) to conclude the purchase of insurance. Step 135 may include providing a link to an individual insurance company website or providing insurance company contact information to the consumer. Step 135 may also include allowing a user to leave contact information for their selected insurance company.

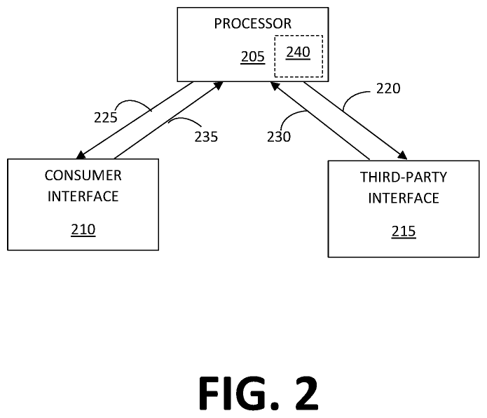

FIG. 2 depicts a block diagram of a system for recommending an insurance carrier in accordance with one embodiment. In some embodiments, a processor 205 may be in communication with a consumer interface 210 and a third-party interface 215. In some embodiments, the processor 205 may be remote from the consumer interface 210.

In some embodiments, a consumer may access a consumer interface 210 to select an insurance carrier. The consumer may input information into the consumer interface 210, such as their insurance carrier preferences and their unique profile. The consumer interface may transfer 235 the information from the consumer interface 210 to the processor 205.

In some embodiments, a third party may access a third-party interface 215 to input information related to an insurance carrier. The third party may be an insurance consumer and may input information regarding their experiences with a specific insurance carrier. The third party may be an insurance carrier and may input information regarding their available insurance plans. In some embodiments, the processor 205 may request 220 the information inputted into the third-party interface 215 and may receive 230 the inputted information.

In some embodiments, the processor 205 may use the collected information from the consumer interface 210 and the third-party interface 215 to calculate the best insurance carrier for the consumer. The processor 205 may output 225 the result to the user at the consumer interface 210. In some embodiments, the output may comprise a ranked list of the available insurance companies. In some embodiments, the processor 205 may also output the results to an insurance company using a third party interface 215 to inform the insurance company about their rank.

In some embodiments, the processor 205 may use a carrier validation tool 240 to ascertain the reliability index of an insurance company. Users may use the tool 240 to ascertain whether an existing insurance company is reliable based upon data inputs collected and aggregated from consumer ratings. Users may be able to compare other insurance brands against their current insurance provider with information from the carrier validation tool to determine if another insurance company is a better fit for their needs.

In some embodiments, the processor 205 may collect data from users 235 to ensure that their risk profile matches up with carriers that prefer to underwrite specific, identifiable risk profiles. For example, in the auto insurance industry, high risk individuals are commonly referred to as “non-standard” risk, and many traditional carriers do not underwrite non-standard risk. The processor 205 may match the risk profile provided by the user at the consumer interface 210 to the data set provided by insurance companies at the third-party interface 215 to include more accurate pricing and options for high risk individuals.

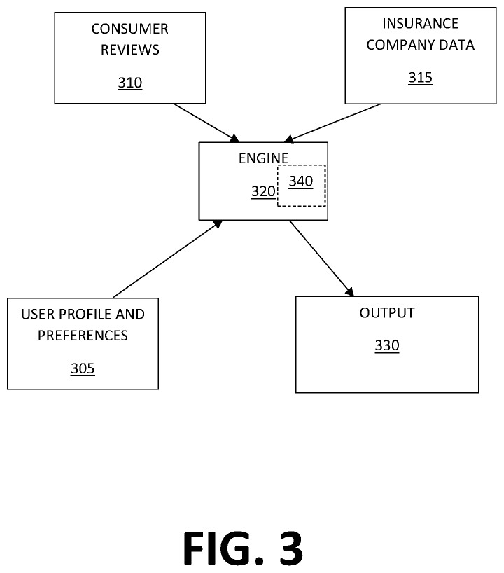

FIG. 3 depicts a block diagram of an insurance recommendation engine in accordance with one embodiment. In some embodiments, the insurance recommendation engine 320 may receive consumer reviews 310 of insurance companies, insurance company data 315 from insurance companies and third-party websites, and a user profile and preferences 305 from a potential insurance consumer. The recommendation engine 320 may use these inputs to calculate an output rating 330 for each carrier, using the input and preferences 305 from the potential insurance consumer. The engine may calculate a score based both on the input and by weighting information from the consumer reviews 310 and the insurance company data 315. In some embodiments, the engine may include a memory to store the insurance company data 315, consumer reviews 310, and profile and preference data from potential consumers 305.

In some embodiments, the ratings data may be time limited, such that the score may be based only on the last two years' worth of data ratings, or that older data may be weighted less in the calculation. In some embodiments, the engine 320 may only use completed reviews of an insurance carrier in the calculation of the output 330. In some embodiments, if a consumer chooses not to rate an insurance carrier on a specific category, the insurance carrier will not be negatively impacted.

In some embodiments, the insurance recommendation engine 320 may calculate average rating of price, average rating of service (e.g., general service, billing), average rating of renewal of a policy, and average rating of claim service (e.g., service received based on the filing of an insurance claim) for each insurance carrier. The insurance recommendation engine 320 may then produce an average rating of each insurance carrier and may output the average rating 330 to the potential consumer at a user interface. The output 330 may also include at least one of the highest score of the insurance carriers (where the highest score may include the highest consumer rating of the insurance carriers), the lowest price of the insurance carriers, best customer service, easiest claim process, or the best value calculated from the received ratings and data. In some embodiments, the output may include visual indicators showing the best scoring insurance carriers in at least one of the value, price, claim process, and consumer ratings categories. In some embodiments, the output 330 may be sorted in descending order based on the calculated score and sent to the potential insurance consumer.

In some embodiments, the consumer may review their insurance company 310 by providing a written review of the insurance company. The insurance engine 320 may verify that the consumer writing the review is, or previously was, a customer of the insurance company in some embodiments. In some embodiments, the insurance engine 320 may have a translator 340 configured to translate natural language written reviews to a numerical grade and can compute scores for the insurance carriers based on the numerical grade. In some embodiments, the consumer may review their insurance company 310 by ranking the company in a series of categories on a numerical scale. For example, the user may rank the insurance company as a “5” on customer interaction but a “3” on price value. In some embodiments, the written and ranked reviews may comprise a customer rating calculation.

In some embodiments, a consumer may elect to choose from multiple categories of “pros,” things that an insurance carrier does well, and “cons,” aspects on which insurance carriers could improve. The engine 320 may convert the total number of “pro” boxes and “con” boxes into a pro/con comparison value, weight the value, and use the value as part of the output calculation 330. In some embodiments, the engine may use the pro/con comparison value and the customer rating calculation to output 330 an insurance carrier score.

In some embodiments, the engine 320 may use the number of reviews associated with an insurance carrier to weight the output score 330. For example, if an insurance carrier has 100 reviews, the average review is more likely to represent an average consumer opinion than an insurance carrier with only five reviews. The engine 320 may weight the insurance carrier with fewer reviews lower than the insurance carrier with 100 reviews to account for potential uncertainty in the collected reviews. In some embodiments, once the number of reviews reaches a certain numeric threshold, the engine 320 will not apply a weight to the insurance carrier score calculation.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for recommending an insurance carrier, the method comprising:
receiving at least one user preference from a consumer;
receiving, from at least one third party, at least one rating for each of a plurality of insurance carriers;
computing scores for each of the plurality of insurance carriers, the score based on the received at least one user preference and the received ratings; and
recommending the insurance carrier with the highest score to the consumer.

2. The method of claim 1, wherein the at least one user preference is selected from the group comprising risk profile, price, area availability, customer support, coverage, buying preference, and reliability.

3. The method of claim 2, wherein the at least one user preference further comprises a ranked preference among at least two other user preferences.

4. The method of claim 1, further comprising facilitating communications between the consumer and the recommended insurance carrier to enable the purchase of an insurance policy.

5. The method of claim 1, wherein the highest score indicates at least one of a high rating, a low price, or a good value assessed from the plurality of ratings.

6. The method of claim 1, wherein the method is executed in a computing environment that is remote from the consumer.

7. The method of claim 1, further comprising receiving data from at least one insurance carrier; and wherein computing scores for each of the plurality of insurance carriers comprises computing scores using the received insurance carrier data.

8. The method of claim 7, wherein the received insurance carrier data comprises at least one of type of insurance, affinity served, consumer type, pricing data, coverage area, and purchasing information.

9. The method of claim 1, wherein the at least one rating is selected from the group consisting of price, rating, customer service, and claim process.

10. The method of claim 1, wherein the at least one rating is selected from the group comprising price, rating, customer service, and claim process.

11. A system configured to recommend an insurance carrier, the system comprising:
a consumer interface;
a third party interface; and
a processor, the processor configured to:
receive at least one user preference from a consumer at the consumer interface;
receive, from at least one third party, at least one rating for each of a plurality of insurance carriers at the third party interface;
compute scores for each of the plurality of insurance carriers, the score based on the received at least one user preference and the received ratings; and output a recommendation of the insurance carrier with the highest score to the consumer at the consumer interface.

12. The system of claim 11, wherein the insurance carrier may comprise at least one of a homeowner insurance, auto insurance, renter insurance, or motorcycle insurance carrier.

13. The system of claim 11, wherein the at least one user preference is selected from the group comprising at least one of risk profile, price, area availability, customer support, coverage, buying preference, and reliability.

14. The system of claim 13, wherein the at least one user preference further comprises a ranked preference among at least two other user preferences.

15. The system of claim 11, wherein the plurality of ratings are numerical ratings.

16. The system of claim 11, wherein the highest score indicates at least one of a high rating, a low price, or a good value assessed from the plurality of ratings.

17. The system of claim 11, further comprising a translator configured to translate natural language of the plurality of third party ratings to a numerical grade, wherein the processor is configured to compute scores for each of the plurality of insurance carriers based on the numerical grade.

18. The system of claim 11 wherein the processor is further configured to receive data from at least one insurance carrier and compute scores for each of the plurality of insurance carriers based on the received insurance carrier data.

19. The system of claim 18, wherein the received insurance carrier data comprises at least one of type of insurance, affinity served, consume type, pricing data, coverage area, and purchasing information.

20. The system of claim 11, wherein the at least one rating is selected from a group consisting of price, customer service, and claim process.
